(19) United States
(12) Patent Application Publication
(10) Pub. No.: US 2024/0106177 A1
(43) Pub. Date: Mar. 28, 2024

(54) A MODULAR ELECTRICAL CONNECTING APPARATUS

(71) Applicant: Jason Andrew Roper, 1692 Midrand (ZA)

(72) Inventor: Jason Andrew Roper, 1692 Midrand (ZA)

(21) Appl. No.: 18/275,918

(22) PCT Filed: Feb. 10, 2022
(86) PCT No.: PCT/ZA2022/050004

§ 371 Date: Aug. 4, 2023

(30) Foreign Application Priority Data
Feb. 11, 2021 (ZA) 2021/00937

(51) Int. Cl. H01R 31/06; H01R 13/717; H04B 3/54

(52) U.S. Cl. CPC H01R 31/065; H01R 13/7175; H04B 3/54

(57) ABSTRACT

The invention relates to an electrical connecting apparatus, more specifically but not exclusively, to a modular electrical connecting apparatus which includes a housing (9), a power inlet socket (12) associated with the housing, a circuit board (20) for connecting the electronic components of the apparatus (10), the circuit board (20) being associated with the housing (9) and a power outlet connector (14) associated with the housing (9), whereas the power inlet socket (12) and power outlet connector (14) are in electrical communication and where one or more electronic modules can be associated with the apparatus (10).

The invention relates to an electrical connecting apparatus, more particularly, but not exclusively, a modular electrical connecting apparatus.

### BACKGROUND ART

The average consumer owns numerous electronic devices. Some consumers may wish to travel with one or more of these devices. When a consumer travels to a different country, there exists the possibility and difficulty that the type of electrical plugs used in such countries, are different than those used in the country in which the consumer is resident.

Seeing as different countries may have different electrical plug systems, the need exists to provide for a versatile solution where electrical connectors that are more universal can be used in different countries irrespective of the electrical plugs used in such country.

Additionally, a consumer may have a specific need in his/her residence or when travelling with respect to the specific different electronic devices he/she wishes to connect to a power supply or other network interface connections that the consumer wishes to utilise.

Furthermore, a consumer may wish to change the electrical connection system from time to time in his/her residence.

Consumers also may have a need to combine different electronic modules in a single electrical connection apparatus to be used.

Moreover, existing electrical connectors are housings of a nature that the internally componentry cannot visually be seen.

It is an object of this invention to provide a modular electrical connecting apparatus which, at least partially, alleviates some of the abovementioned difficulties.

### SUMMARY OF INVENTION

In accordance with this invention there is provided a modular electrical connecting apparatus, comprising:

a housing, a power inlet socket associated with the housing, a circuit board for connecting the electronic components of the apparatus, the circuit board being associated with the housing and a power outlet connector associated with the housing, whereas the power inlet socket and power outlet connector are in electrical communication and where one or more electronic modules can be associated with the apparatus.

The apparatus includes a surge protecting module that is associated with the electric circuit of the apparatus.

The apparatus includes a network interface module that is associated with the electric circuit of the apparatus.

The network interface module is a registered jack for connecting telecommunications equipment.

The network interface module is a registered jack for connecting data equipment.

The apparatus includes a cable connection interface module that is associated with the electric circuit of the apparatus.

The cable connection interface module is a universal serial bus.

The housing includes a semi-transparent portion as to allow the internal components to be viewed by a user.

The apparatus includes one or more light components that is associated with the circuit board of the apparatus.

The one or more light components are in the form of a light emitting diode.

The one or more light components are in the form of neon light units.

The one or more light components serve to indicate whether the power surge module is in a working condition.

The one or more light components serve to indicate electrical faults from the power source.

The one or more light components serve to indicate whether the wiring to the apparatus is faulty.

The one or more light components serve to indicate whether any of the live, neutral or earth wires are faulty.

The power inlet socket and the power outlet connector are in electrical communication and bypasses the circuit board.

The live and neutral wires are connected from the power inlet socket directly to the power outlet connector to the exclusion of the circuit board, the earth wire being connected to the circuit board.

### BRIEF DESCRIPTION OF DRAWINGS

FIG. 1 shows a front-right perspective view of a modular electrical connecting apparatus with an I EC C 13 power outlet connector and a network interface module.

FIG. 2 shows a rear-left perspective view of FIG. 1 with an IEC C14 power inlet socket.

FIG. 3 shows a side perspective view of a modular electrical connecting apparatus illustrating one embodiment which includes a network interface module.

FIG. 4 shows a side perspective view of a modular electrical connecting apparatus illustrating one embodiment which includes a cable connection interface module in the form of a universal serial bus port.

FIG. 5 shows a side perspective view of a modular electrical connecting apparatus illustrating one embodiment which includes light components.

FIG. 6 shows an open top view of the apparatus which includes more than one electronic module.

FIG. 7 shows an open top view of the apparatus which includes one electronic module in the form of a network interface module.

FIG. 8 shows an open top view of the apparatus which includes one electronic module in the form of a surge protector module.

FIG. 9 shows a perspective view of the modular electrical connecting apparatus illustrating the electrical connections to allow electrical current flow and data connections to allow data transfer.

FIG. 10 shows an in-use perspective view where the modular electrical connecting apparatus is used to provide electrical power and telecommunications connections.

FIG. 11 shows a perspective view of the modular electrical connecting apparatus illustrating one embodiment in relation to the type of electrical connection that can be used.

FIG. 12 shows a perspective view of the modular electrical connecting apparatus illustrating another embodiment in relation to the type of electrical connection that can be used.

FIG. 13 shows a front-right perspective view of a modular electrical connecting apparatus with an IEC C19 power outlet connector.

FIG. 14 shows a rear-left perspective view of FIG. 13 with an I EC C20 power inlet socket

FIG. 15 shows a perspective view where two units of the apparatus which have been connected to one another in a daisy chain like manner.

FIG. 16 shows an open top view of two units of the apparatus which have been connected to one another in a daisy chain like manner.

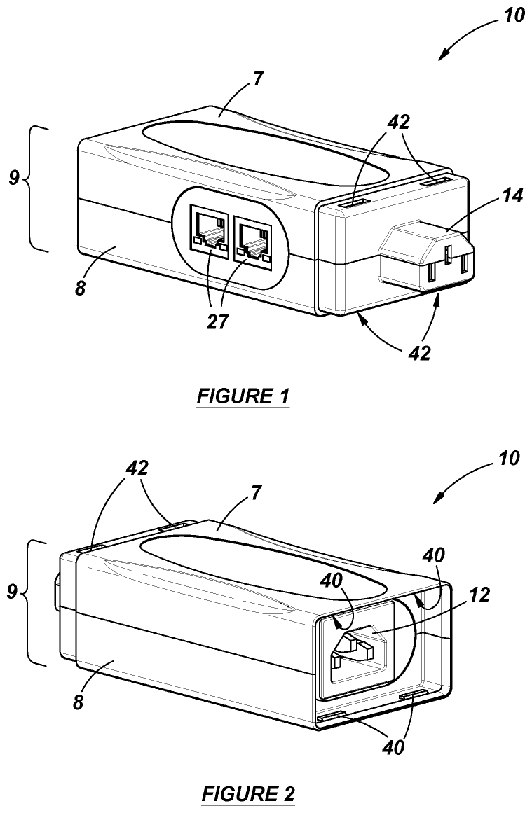

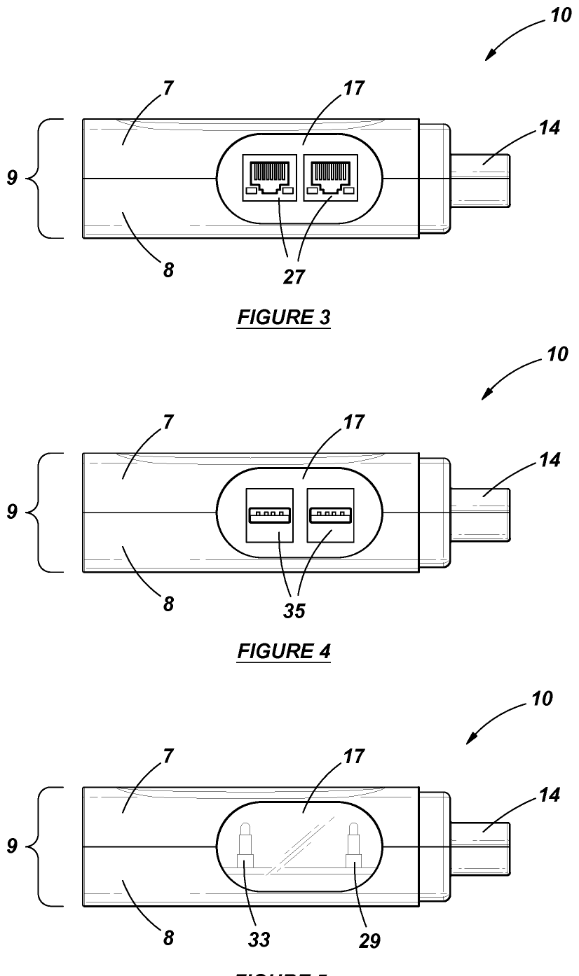

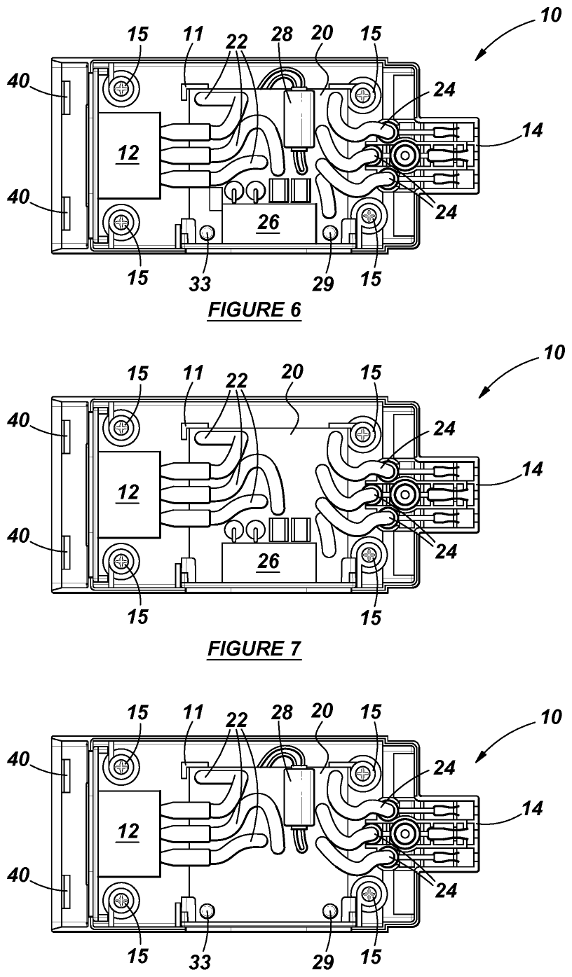

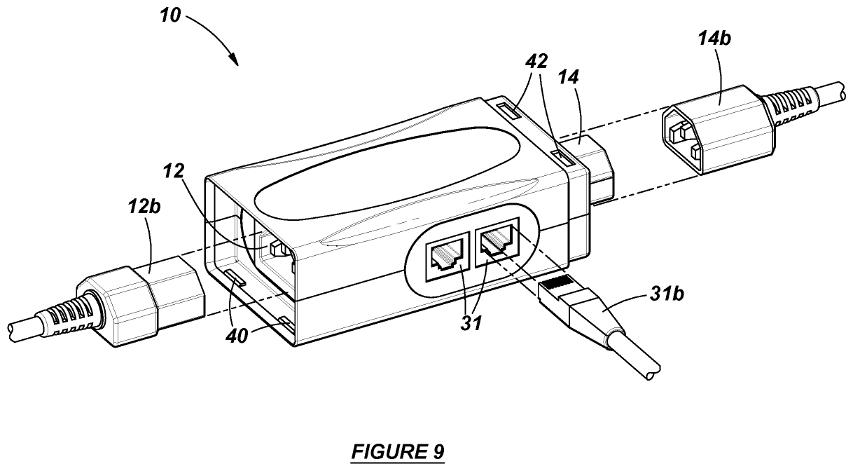

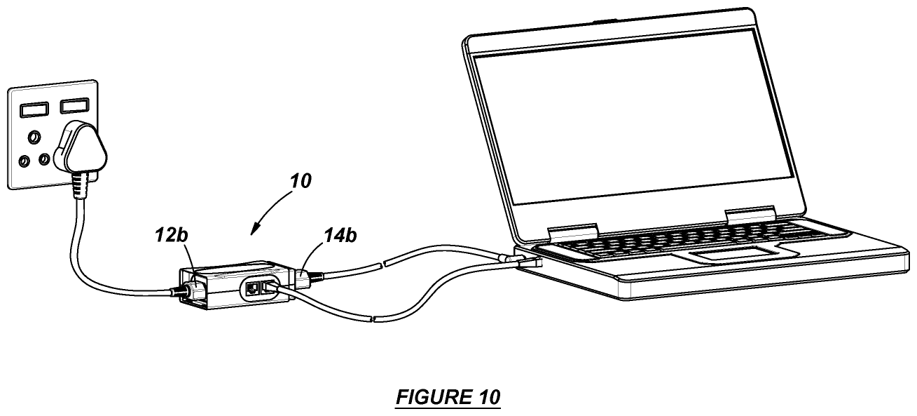

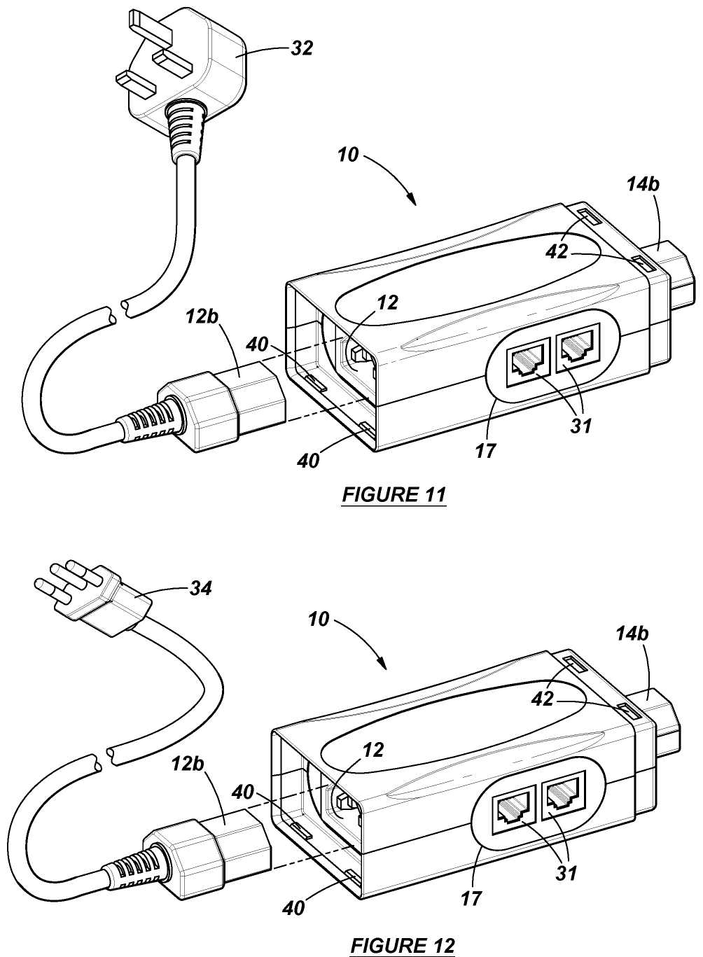

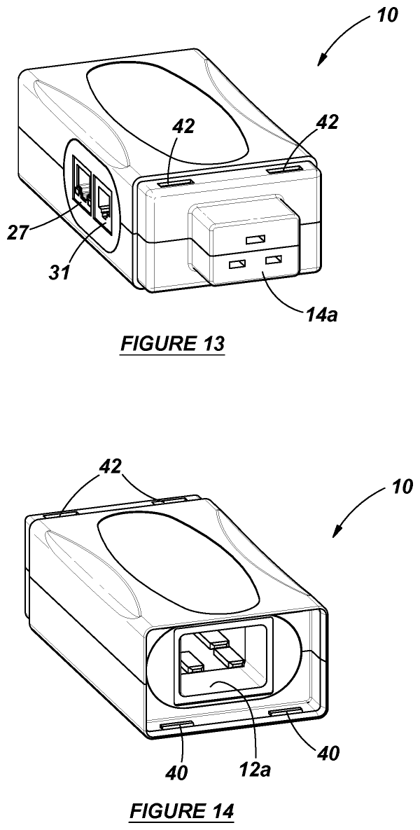

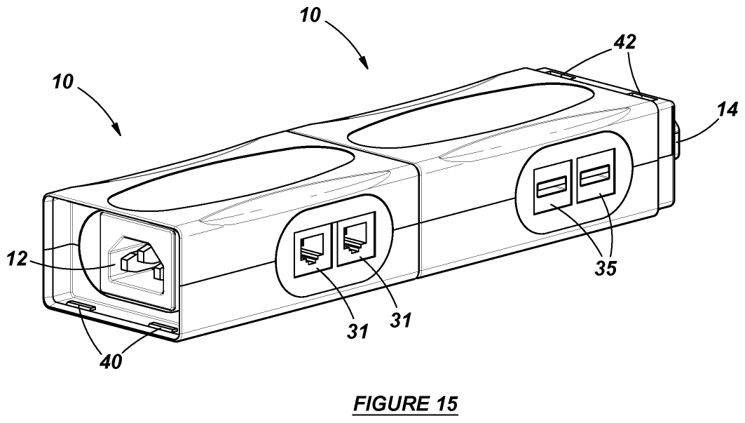

### DESCRIPTION OF THE EMBODIMENTS

With reference to the drawings, in which like numerals refer to like features, a modular electrical connecting apparatus is generally indicated by reference numeral 10.

In this embodiment, the modular electrical connecting apparatus comprises of a housing (9) having a top portion (7) and a bottom portion (8). The top portion (7) and the bottom portion (8) are connected to one another with any conventional fixing method. In this embodiment, the top portion (7) and a bottom portion (8) are connected to one another by means of one or more screws configured in screw threaded holes (15) which align in both the top portion (7) and a bottom portion (8) of the housing (9).

In this embodiment of the invention, a power inlet socket (12) is configured in a side wall of the housing (9), however, the power inlet socket (12) can be associated with the housing in any suitable manner. The housing (9) also includes a power outlet connector (14) for providing electrical current apparatus (10). The power inlet socket (12) and power outlet connector (14) are in electrical communication.

Inside the housing (9) a circuit board (20) is configured within brackets (11) of the housing (9) for connecting all the components of the modular electrical connecting apparatus (10).

Different electronic modules can be configured to the circuit board (20).

In one embodiment of the invention, the apparatus (10) includes a surge protecting module (28) and a network interface module (26). The network interface module (26) can be any type of network interface module such as a registered jack connector of any type. A registered jack is a standardized telecommunications network interface which is used to connect voice and data equipment to a service provided by a local exchange carrier or long-distance carrier.

In this regard, one embodiment includes a registered jack for connecting telecommunications equipment (31) and/or a registered jack for connecting data equipment (27). Examples of these types of connectors can include RJ45 connectors, ethernet or local access network cables.

In another embodiment, the apparatus (10) includes only a surge protecting module (28).

In yet a further embodiment, the apparatus (10) includes a cable connection interface module in the form of a universal serial bus (35).

The apparatus (10) is modular in the sense that a plurality of different modules can be configured within the apparatus (10) depending on the requirements of the user.

The apparatus further includes a first light emitting diode (29) which, if illuminated, confirms the surge protecting module (28) is in a functioning condition.

The apparatus further includes a second light emitting diode (33) which, if illuminated, confirms that there exists a problem with the circuitry of the apparatus and that electrical current is not relayed through the apparatus. It is to be appreciated that the first and second light emitting diodes (29 & 33) are not a requirement but provides additional functionalities.

Additionally, the light components can have any variety of functions such as, amongst others, to indicate faults in:
different modules;
the power source;
in the wiring of the apparatus; and/or any of the live, neutral or earth wires.

It is to be appreciated that although the disclosed embodiment uses light emitting diodes, any light emitting unit can be used to fulfil the same functions.

Furthermore, a further embodiment can include a module which includes its own light unit to indicate a certain status of the module or the circuitry of the apparatus.

It is to be appreciated that the one or more light components can be configured to indicate any relevant condition, status or functionality applicable to the apparatus.

The power inlet socket (12) is configured to the circuit board (20) by means of conventional wiring of live, neutral and earth wires (22). The power outlet connector (14) is configured to the circuit board (20) in a similar manner as the power inlet socket (12) as to ensure electrical current can flow from the power inlet socket (12), through the circuit board (20) and any electronic module that requires electrical current and out the power outlet connector (14). The wiring of the power outlet connector (14) is depicted by reference numeral 24. Any acceptable electrical wiring can be used.

In one embodiment of the invention, the power inlet and the power outlet bypass the circuit board.

In one embodiment of the invention, the live and neutral wires will bypass the circuit board while the earth wire is connected with the circuit board.

In one embodiment of the invention, the power inlet socket (12) is an IEC (International Electrotechnical Commission) C14 connector. The power outlet connector (14) is an IEC C13 connector. In use, a user will use a complementary IEC C13 cord (12b) to connect the apparatus to a power source. If required, the user can obtain an IEC C14 cord (14b) to connect the apparatus to an electronic device such as, for instance, a desktop computer. It is to be appreciated that the invention can be manufactured to incorporate any available IEC approved couplers. Alternative power inlet sockets such as an IEC C20 (12a) and power outlet connectors such as IEC 19 (14a) can be used in the apparatus. Again, it is to be appreciated that any like socket and connectors can be used for the invention.

The plug portion of the IEC C13 cord (12b) can be any type depending on the type of power socket that the user will use, usually dictated by the power plug system used by the country in which the user finds himself/herself. In illustrating the aforementioned, different power plugs (32 & 34) can be used.

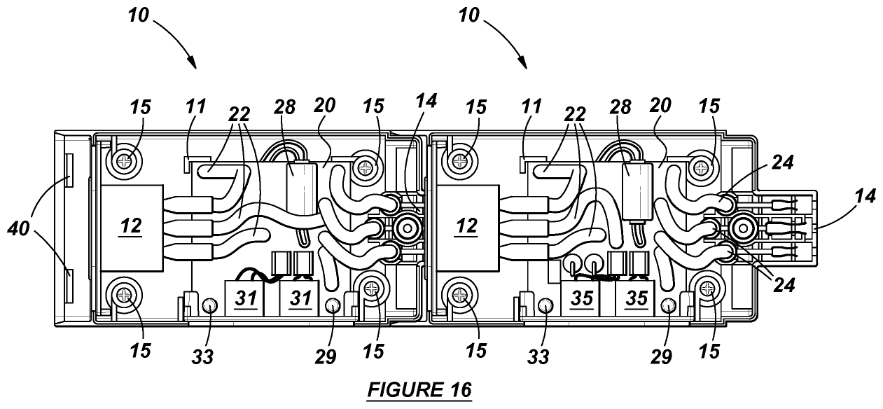

As shown in FIG. 15 and FIG. 16, one unit of the apparatus is capable of being connected to another unit of the apparatus whilst maintaining electrical current throughout the units. Each apparatus has connecting protrusions 40 at a first end and complementary connecting slits 42 at another end to facilitate the connecting of the different units. When the units are connected, the connecting protrusions (40) will slide into a retaining position within the complementary connecting slits (42). An electrical connection will then be established where a power inlet socket (12) of one unit of the apparatus will receive a power outlet connector (14) of another unit of the apparatus.

Numerous units can be connected to one another in a daisy chain like manner. Alternatively put, the power inlet socket (12) can be described as a female connection type and the power outlet connector (14) can be described as a male connection type where the different units are connected in a male-female connection type manner.

Another embodiment includes a window portion (17) which serves to enables a user to, at least partially, view the inside of the apparatus.

1. A modular electrical connecting apparatus, comprising:
a housing;
a power inlet socket associated with the housing;
a circuit board for connecting the electronic components of the apparatus, the circuit board being associated with the housing;
a power outlet connector associated with the housing, where the power inlet socket and power outlet connector are in electrical communication and where the apparatus is capable of including one or more different electronic modules.

2. The apparatus as claimed in claim 1 wherein the apparatus includes a surge protecting module that is associated with the circuit of the apparatus.

3. The apparatus as claimed in claim 1 further including a network interface module that is associated with the circuit of the apparatus.

4. The apparatus as claimed in claim 1 wherein the network interface module is a registered jack for connecting telecommunications equipment.

5. The apparatus as claimed in claim 1 wherein the network interface module is a registered jack for connecting data equipment.

6. The apparatus as claimed in claim 1 further including a cable connection interface module that is associated with the circuit of the apparatus.

7. The apparatus as claimed in claim 6 wherein the cable connection interface module is a universal serial bus.

8. The apparatus as claimed in claim 1 wherein the housing includes a semi-transparent like portion as to allow the internal components to be, at least partially, viewed by a user.

9. The apparatus as claimed in claim 1 further including one or more light components associated with the circuit of the apparatus.

10. The apparatus as claimed in claim 9 wherein the one or more light components are in the form of a light emitting diode.

11. The apparatus as claimed in claim 9 wherein the one or more light components are in the form of a neon light unit.

12. The apparatus as claimed in claim 9 wherein the one or more light components serve to indicate whether the power surge module is in a working condition.

13. The apparatus as claimed in claim 9 wherein the one or more light components serve to indicate electrical faults from the power source.

14. The apparatus as claimed in claim 9 wherein the one or more light components serve to indicate whether the wiring to the apparatus is faulty.

15. The apparatus as claimed in claim 9 wherein the one or more light components serve to indicate whether any of the live, neutral or earth wires are faulty.

16. The apparatus as claimed in claim 9 wherein the one or more light components serve to indicate any relevant condition, status or functionality applicable to the apparatus.

17. The apparatus as claimed in claim 1 where the power inlet socket and the power outlet connector are in electrical communication and bypasses the circuit board.

18. The apparatus as claimed in claim 1 wherein the live and neutral wires are connected from the power inlet socket directly to the outlet connector to the exclusion of the circuit board, the earth wire being connected to the circuit board.

19. (canceled)
